(19) United States
(12) Patent Application Publication
(10) Pub. No.: US 2008/0046537 A1
(43) Pub. Date: Feb. 21, 2008

(54) System and method for alerting a user of the availability of web feeds

(75) Inventors: Jeffrey M. Chasen, Redmond, WA (US); Timothy Graham, Seattle, WA (US)

Correspondence Address: HOLLAND & KNIGHT LLP, 10 ST. JAMES AVENUE, BOSTON, MA, 02116, US

(73) Assignee: RealNetworks, Seattle, WA (US)

(21) Appl. No.: 11/506,449

(22) Filed: Aug. 18, 2006

(51) Int. Cl. G06F 15/16

(52) U.S. Cl. 709/217; 709/203

(57) ABSTRACT

A method, computer program product, and client device for selecting an identifier on a display of the client device, the identifier corresponding to a website having one or more web pages stored on a server. In response to selecting an identifier, an indication is transmitted to a server requesting that at least one of the web pages be transmitted to the client device. The web page is received and rendered on the display of the client device. A datastore is queried to determine if at least one web feed is available on the website. The datastore includes feed information that defines web feeds available on the website. In response to the availability of at least one web feed on the website, an indicator is rendered with the client device indicative of the availability of the at least one web feed on the website.

### TECHNICAL FIELD

This disclosure relates to web feeds and, more particularly, to automatically alerting a user of the availability of web feeds.

### BACKGROUND

When using a browser to visit websites, web feeds (e.g., Really Simple Syndication (i.e., RSS) feeds, or atom feeds, for example) may be available at the website. Users may use web feed readers to access these feeds and web feed search engines (e.g., www.feedster.com) to search for available web feeds. Typically, the web feed search engines maintain databases that define what web feeds are available on various websites.

On some websites on which web feeds are available, the author of the website may include HTML/XML tags that are indicative of the availability of web feeds on the website. When these websites are viewed by a compatible browser (e.g., Microsoft Internet Explorer™ v7.00), the browser will recognize these tags and indicate to the user the availability of web feeds on the website. However, these HTML/XML tags typically only work on a per page basis (i.e., the tags will not indicate the availability of a web feed on a subpage). Additionally, the website must be custom programmed to include the HTML/XML tags and, if the tags are missing, the compatible browser will not know that web feeds are available on the website. Additionally, if a website (which contains the appropriate HTML/XML tagging) is viewed by a non-compatible browser, the non-compatible browser will not know that web feeds are available on the website.

### SUMMARY OF DISCLOSURE

In a first implementation, a method includes selecting an identifier on a display of a client device, the identifier corresponding to a website having one or more web pages stored on a server. In response to selecting an identifier, an indication is transmitted to a server requesting that at least one of the web pages be transmitted to the client device. The web page is received and rendered on the display of the client device. A datastore is queried to determine if at least one web feed is available on the website. The datastore includes feed information that defines web feeds available on the website. In response to the availability of at least one web feed on the website, an indicator is rendered with the client device indicative of the availability of the at least one web feed on the website.

### BRIEF DESCRIPTION OF THE DRAWINGS

FIG. 1 is a diagrammatic view of a FAN process and a client device coupled to a distributed computing network;

FIG. 2 is a diagrammatic view of a display screen rendered by the client device of FIG. 1;

FIG. 3 is a flowchart of a process executed by the FAN process of FIG. 1; and

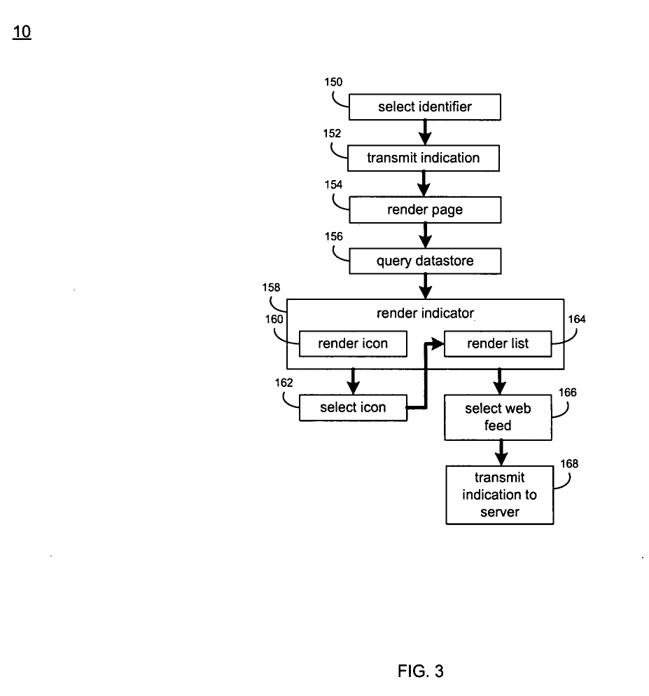

FIG. 4 is a diagrammatic view of a display screen rendered by the client device of FIG. 1.

### DETAILED DESCRIPTION OF THE PREFERRED EMBODIMENTS

### System Overview:

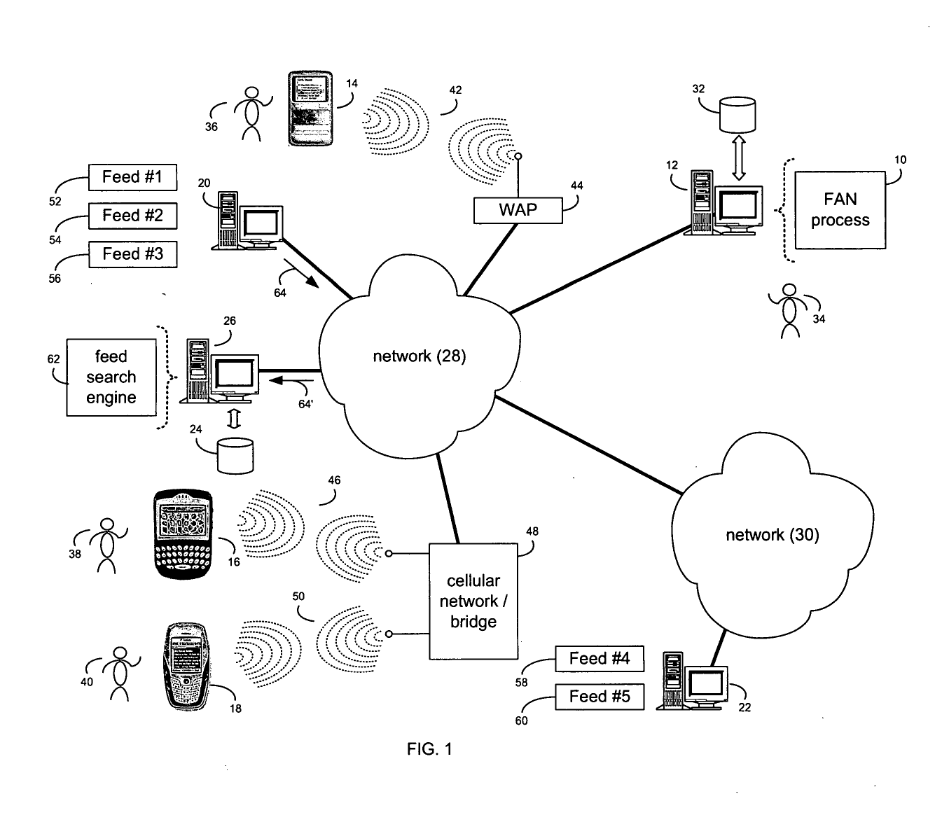

Referring to FIG. 1, there is shown a feed availability notification (i.e., FAN) process 10 that may reside on and be executed by a client device, examples of which may include but are not limited to a client computer 12, personal media device 14, personal digital assistant 16, cellular telephone 18, a laptop computer (not shown), a notebook computer (not shown), a pager (not shown), a television (not shown), a cable box (not shown), a gaming device (e.g., a Microsoft Xbox™, not shown), and a portable gaming device (e.g., a Sony Playstation™ Portable, not shown), for example.

As will be discussed below in greater detail, in response to a user visiting a website served by e.g., feed servers 20, 22, FAN process 10 may query datastore 24 (e.g., a database and/or system memory) served by search engine server 26 to determine if any web feeds are available at the website currently being visited by the user. If any web feeds are available, FAN process 10 may notify the user of the availability of the web feeds.

Examples of feed servers 20, 22 and search engine server 26 may include but are not limited to: a personal computer, a mini computer, or mainframe computer, for example. Feed servers 20, 22 and search engine server 26 may each be a web server (or a series of servers) running a network operating system, examples of which may include but are not limited to: Microsoft Windows 2003 Server™; Novell Netware™; or Redhat Linux™, for example.

Feed servers 20, 22 and search engine server 26 may also execute a web server application, examples of which may include but are not limited to: Microsoft IIS™, Novell Webserver™, or Apache Webserver™, that allows for HTTP (i.e., HyperText Transfer Protocol) access to feed servers 20, 22 and search engine server 26 via network 28. Network 28 may be connected to one or more secondary networks (e.g., network 30), examples of which may include but are not limited to: a local area network; a wide area network; or an intranet, for example.

The instruction sets and subroutines of FAN process 10, which are typically stored on a storage device 32 coupled to the client device (e.g., client computer 12, personal media device 14, personal digital assistant 16, cellular telephone 18, a laptop computer (not shown), a notebook computer (not shown), a pager (not shown), a television (not shown), a cable box (not shown), a gaming device (e.g., a Microsoft Xbox™, not shown), or a portable gaming device (e.g., a Sony Playstation™ Portable, not shown)), may be executed by one or more processors (not shown) and one or more memory architectures (not shown) incorporated into the client device (e.g., client computer 12, personal media device 14, personal digital assistant 16, cellular telephone 18, a laptop computer (not shown), a notebook computer (not shown), a pager (not shown), a television (not shown), a cable box (not shown), a gaming device (e.g., a Microsoft Xbox™, not shown), or a portable gaming device (e.g., a Sony Playstation™Portable, not shown)). Storage device 32 may include but is not limited to: a hard disk drive; a tape drive; an optical drive; a RAID array; a random access memory (RAM); or a read-only memory (ROM).

FAN process 10 may be a stand alone application or an applet running within another program, such as Microsoft Internet Explore™ and Netscape Navigator™, for example). Client computer 12, personal media device 14, personal digital assistant 16, cellular telephone 18, a laptop computer (not shown), a notebook computer (not shown), a pager (not shown), a television (not shown), a cable box (not shown), a gaming device (e.g., a Microsoft Xbox™, not shown), and a portable gaming device (e.g., a Sony Playstation™ Portable, not shown), may each execute an operating system, examples of which may include but are not limited to: Microsoft Windows XP™, Microsoft Windows CE™, Redhat Linux™, or a custom operating system.

Users 34, 36, 38, 40 of client devices 12, 14, 16, 18 (respectively) may access feed servers 20, 22, and search engine server 26 directly through network 28 or through secondary network 30. The various client devices may be directly or indirectly coupled to network 28 (or network 30). For example, client computer 12 is shown directly coupled to network 28 via a hardwired network connection. Further, personal media device 14 is shown wirelessly coupled to network 28 via wireless communication channel 42 established between personal media device 14 and wireless access point (i.e., WAP) 44, which is shown directly coupled to network 28.

WAP 44 may be, for example, an IEEE 802.11a, 802.11b, 802.11g, Wi-Fi, and/or Bluetooth device that is capable of establishing wireless communication channel 42 between personal media device 14 and WAP 44. As is known in the art, all of the IEEE 802.11x specifications use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Personal digital assistant 16 is shown wirelessly coupled to network 28 via wireless communication channel 46 established between personal digital assistant 16 and cellular network/bridge 48, which is shown directly coupled to network 28. Further, cellular telephone 18 is shown wirelessly coupled to network 28 via wireless communication channel 50 established between cellular telephone 18 and cellular network/bridge 48, which is shown directly coupled to network 28.

### The FAN Process:

As discussed above, when a user (e.g., users 34, 36, 38, 40) visits a website, one or more web feeds (e.g., web feeds 52, 54, 56, 58, 60) may be available at the website. These web feeds are typically hosted by feed servers (e.g., feed servers 20, 22) and accessed and viewed with a web feed reader application. FAN process 10 may include or be a portion of a web feed reader application. Accordingly, FAN process 10 may allow a user to access and review the web feeds.

As discussed above, an example of a web feed is an RSS news feed, which allows for the simplified syndication of digital content via network 28 and/or network 30. Many website, examples of which may include but are not limited to www.foxnews.com, www.cnn.com, www.reuters.com, and www.bbc.com offer digital content (e.g., news headlines and/or stories, for example) via web feeds.

Web feed search engines (e.g., www.feedster.com) 62 allow users to search for available web feeds and determine which web feeds are available at various websites. Web feed search engine 62 may be executed on search engine server 26 coupled to network 28 (or network 30) and may maintain one or more datastores 24 that define the web feeds available on various websites.

Typically, when a web feed (e.g., web feed 52) is added/updated, the feed server (e.g., feed server 20) hosting the added/updated web feed sends a notification (e.g., ping 64) to one or more web feed search engines (e.g., web feed search engine 62). Typically, this notification provides web feed search engine 62 with all the information required to identify and locate the added/updated web feed.

Upon receiving the notification (i.e., represented as received ping 64′), web feed search engine 62 may survey the added/updated web feed (e.g., web feed 52). Additionally, the datastores (e.g., datastore 24) maintained by web feed search engine 62 may be updated to reflect the added/updated digital content available at the added/updated web feed (e.g., web feed 52).

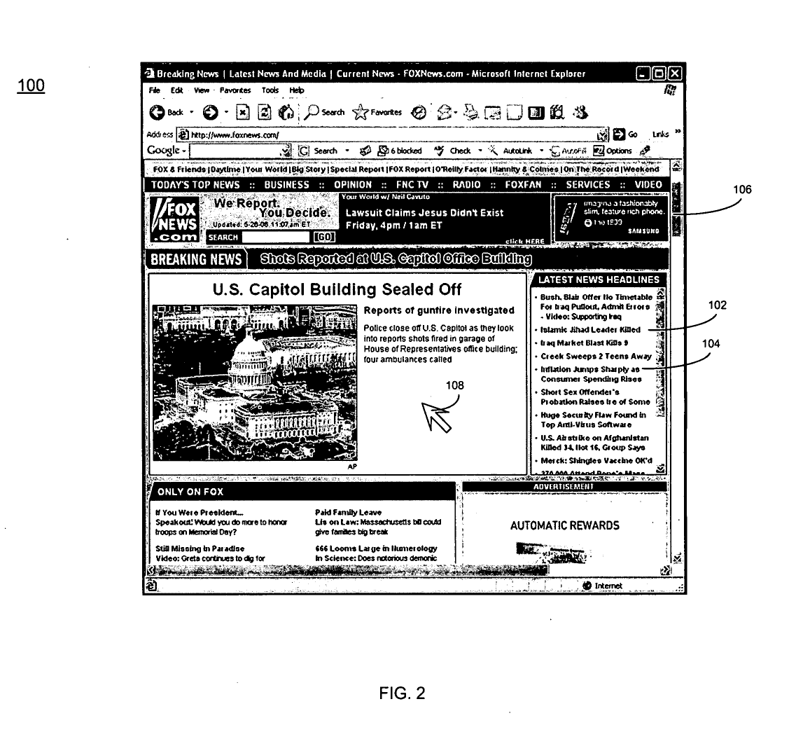

As discussed above, a user (e.g., user 36) may use a client device (e.g., client computer 12) to browse websites. Referring also to FIGS. 2 & 3, when browsing a website, the user (e.g., user 36) may be presented with a web page 100 rendered on a display screen of the client device (e.g., client computer 12). To select a page (or subpage) for browsing, the user may select 150 an identifier (e.g., text-based identifier 102, 104 and/or hyperlinked graphic image 106, for example), which is rendered on the display screen of the client device (e.g., client computer 12) and defines/locates a webpage associated with the identifier. The user (e.g., user 34) may select 150 the identifier using a screen pointer 108 controllable via a pointing device (e.g., a mouse, a joystick, or a keypad, for example) coupled to the client device (e.g., client computer 12).

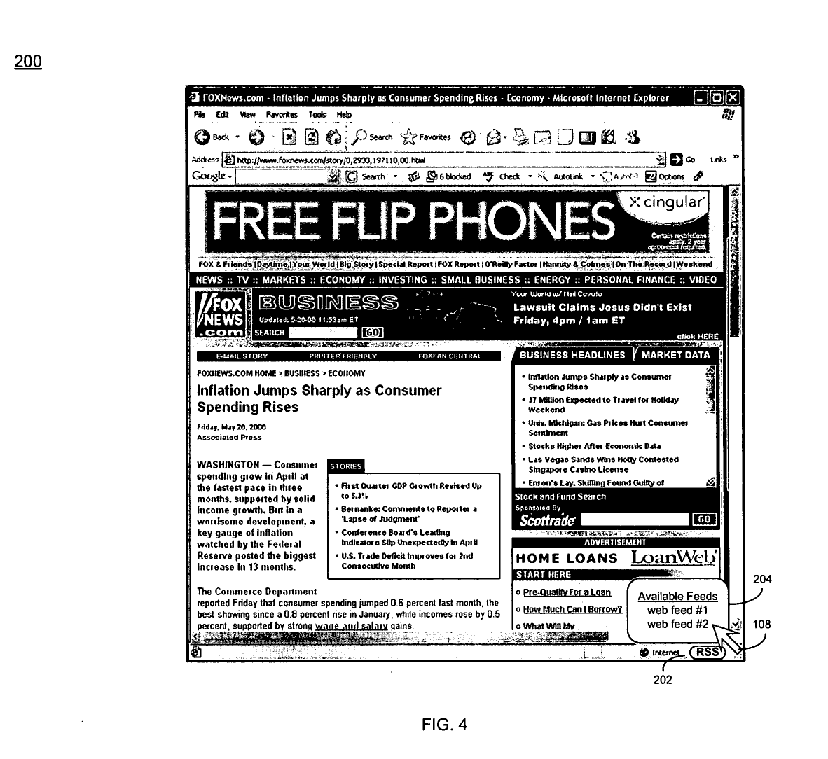

In response to the user (e.g., user 34) selecting 150 an identifier, the client device (e.g., client computer 12) transmits 152 an indication to a server requesting that the web page associated with the selected identifier be transmitted to the client device. For example, if user 36 wanted to view the web page associated with the story “Inflation Jumps Sharply as Consumer Spending Rises”, the user may select 150 identifier 104 (i.e., a text-based identifier) using screen pointer 108. Once the selection 150 is made, the client device (e.g., client computer 12) transmits 152 an indication to e.g., feed server 20 (i.e., the server hosting/serving the website) requesting that the web page associated with identifier 104 be transmitted to the client device (e.g., client computer 12) for rendering. Referring also to FIG. 4, once received from e.g., feed server 20, the web page 200 is rendered on the display screen of the client device (e.g., client computer 12).

In response to web page 200 being rendered, FAN process 10 may query 156 datastore 24 to determine if at least one web feed is available on the website. For this disclosure, “website” is intended to be interpreted broadly to mean any webpage or series of webpages. For example, a single webpage being viewed by a user is considered to be a website for this disclosure, as is the more traditional interpretation of a group of webpages residing under a common domain name.

Examples of datastore 24 include a database (not shown) servable by search engine server 26 and system memory (not shown) controllable by search engine server 26. As discussed above, datastore 24, which is maintained by web feed search engine 62, may define the web feeds available on various websites. Accordingly, by accessing datastore 24 and querying 156 e.g., the uniform resource locator associated with the website) being viewed, a determination may be made concerning what (if any) web feeds are available on the website. Assuming that, after querying datastore 24, two web feeds (i.e., web feeds 52, 54) are available on the website, an indicator may be rendered 158 by FAN process 10 that is indicative of the availability of e.g., web feeds 52, 54. Rendering 158 the indicator may include rendering 160 an icon 202 (e.g., a graphical icon or a text-based icon, for example) that indicates that one or more web feeds are available on the website. In the event that icon 202 is rendered, the user (e.g., user 34) of the client device (e.g., client computer 12) may select 162 icon 202 using screen pointer 108. Once selected 162, FAN process 10 may render 164 a list 204 (on the display screen of the client device) that identifies the web feeds available on the website.

Continuing with the above-stated example, as two web feeds (namely web feeds 52, 54) are available on the website being viewed, list 204 may be rendered 164 to identify the available web feeds. For example, list 204 is shown to include a first entry identifying “web feed #1” (i.e., web feed 52) as being available and a second entry identifying “web feed #2” (i.e., web feed 54) as being available. Each of the entries itemized within list 204 may include and/or define a uniform resource locator (e.g., http://www.foxnews.com/xmlfeed/rss/0,4313,80,00.rss) that locates the particular web feed identified in list 204.

Alternatively, when rendering 158 the indicator, icon 202 need not be rendered 160 prior to the rendering 164 of list 204. Specifically, FAN process 10 may be configured to automatically render list 204 if web feeds are available on the website being viewed.

The user (e.g., user 34) of the client device (e.g., client computer 12) may use screen pointer 108 to select 166 one of more of the web feeds defined within list 204. In response to this selection 166, FAN process 10 may transmit 168 an indication to the server hosting the web feed requesting content for the selected web feed. Continuing with the above-stated example, assume that user 34 selects 166 the first entry identifying “web feed #1” (i.e., web feed 52). As web feed #1 is hosted by feed server 20, FAN process 10 may transmit 168 a content request concerning “web feed #1” to feed server 20. The content requested from feed server 20 may include but is not limited to any combination of full news stories, news story headlines, video clips, audio clips, weblog files, and graphic files, for example. Once the content request is received by feed server 20, feed server 20 may subsequently transmit the requested content to the client device (e.g., client computer 12).

While datastore 24 is defined as being coupled to search engine server 26, other configurations are possible and are considered to be within the scope of this disclosure. For example, datastore 24 may be coupled to a different server or may be replicated across multiple servers.

A number of implementations have been described. Nevertheless, it will be understood that various modifications may be made. Accordingly, other implementations are within the scope of the following claims.

What is claimed is:

1. A method comprising:
selecting an identifier on a display of a client device, the identifier corresponding to a website having one or more web pages stored on a server;
in response to selecting an identifier, transmitting an indication to a server requesting that at least one of the web pages be transmitted to the client device;
receiving and rendering the web page on the display of the client device;
querying a datastore to determine if at least one web feed is available on the website, the datastore including feed information that defines web feeds available on the website; and
in response to the availability of at least one web feed on the website, rendering an indicator with the client device indicative of the availability of the at least one web feed on the website.

2. The method of claim 1 wherein rendering an indicator includes:
rendering an icon on the display of the client device, wherein the icon is selectable using the client device.

3. The method of claim 2 further comprising:
selecting the icon using the client device; and
in response to selecting the icon, rendering a list on the display of the client device that identifies one or more web feeds available on the website.

4. The method of claim 3 further comprising:
selecting at least one of the one or more web feeds available on the website; and
transmitting an indication to the server requesting content from the at least one of the one or more web feeds available on the website.

5. The method of claim 1 wherein rendering an indicator includes:
rendering a list on the display of the client device that identifies one or more web feeds available on the website.

6. The method of claim 5 further comprising:
selecting at least one of the one or more web feeds available on the website; and
transmitting an indication to the server requesting content from the at least one of the one or more web feeds available on the website.

7. The method of claim 1 wherein the client device is chosen from the group consisting of: a desktop computer; a laptop computer; a notebook computer; a personal digital assistant; a wireless network device; a cable television box; a television, a gaming device, and a cellular telephone.

8. A computer program product residing on a computer readable medium, having a plurality of instructions stored thereon that, when executed by a processor, cause the processor to perform operations comprising:
selecting an identifier on a display of a client device, the identifier corresponding to a website having one or more web pages stored on a server;
in response to selecting an identifier, transmitting an indication to a server requesting that at least one of the web pages be transmitted to the client device;
receiving and rendering the web page on the display of the client device;
querying a datastore to determine if at least one web feed is available on the website, the datastore including feed information that defines web feeds available on the website; and
in response to the availability of at least one web feed on the website, rendering an indicator with the client device indicative of the availability of the at least one web feed on the website.

9. The computer program product of claim 8 wherein the instructions for rendering an indicator include instructions for performing operations comprising:
rendering an icon on the display of the client device, wherein the icon is selectable using the client device.

10. The computer program product of claim 9 further comprising instructions for performing operations comprising:
selecting the icon using the client device; and
in response to selecting the icon, rendering a list on the display of the client device that identifies one or more web feeds available on the website.

11. The computer program product of claim 10 further comprising instructions for performing operations comprising:
selecting at least one of the one or more web feeds available on the website; and
transmitting an indication to the server requesting content from the at least one of the one or more web feeds available on the website.

12. The computer program product of claim 8 wherein the instructions for rendering an indicator include instructions for performing operations comprising:
rendering a list on the display of the client device that identifies one or more web feeds available on the website.

13. The computer program product of claim 12 further comprising instructions for performing operations comprising:
selecting at least one of the one or more web feeds available on the website; and
transmitting an indication to the server requesting content from the at least one of the one or more web feeds available on the website.

14. The computer program product of claim 8 wherein the client device is chosen from the group consisting of: a desktop computer; a laptop computer; a notebook computer; a personal digital assistant; a wireless network device; a cable television box; a television, a gaming device, and a cellular telephone.

15. A client device configured to perform operations comprising:
selecting an identifier on a display of the client device, the identifier corresponding to a website having one or more web pages stored on a server;
in response to selecting an identifier, transmitting an indication to a server requesting that at least one of the web pages be transmitted to the client device;
receiving and rendering the web page on the display of the client device;
querying a datastore to determine if at least one web feed is available on the website, the datastore including feed information that defines web feeds available on the website; and
in response to the availability of at least one web feed on the website, rendering an indicator with the client device indicative of the availability of the at least one web feed on the website.

16. The client device of claim 15 wherein rendering an indicator includes:
rendering an icon on the display of the client device, wherein the icon is selectable using the client device.

17. The client device of claim 16, wherein the client device is further configured to perform operations comprising:
selecting the icon using the client device; and
in response to selecting the icon, rendering a list on the display of the client device that identifies one or more web feeds available on the website.

18. The client device of claim 17, wherein the client device is further configured to perform operations comprising:
selecting at least one of the one or more web feeds available on the website; and
transmitting an indication to the server requesting content from the at least one of the one or more web feeds available on the website.

19. The client device of claim 15 wherein rendering an indicator includes:
rendering a list on the display of the client device that identifies one or more web feeds available on the website.

20. The client device of claim 19, wherein the client device is further configured to perform operations comprising:
selecting at least one of the one or more web feeds available on the website; and
transmitting an indication to the server requesting content from the at least one of the one or more web feeds available on the website.

21. The client device of claim 15 wherein the client device is chosen from the group consisting of: a desktop computer; a laptop computer; a notebook computer; a personal digital assistant; a wireless network device; a cable television box; a television, a gaming device, and a cellular telephone.
